(19) United States
(12) Patent Application Publication
(10) Pub. No.: US 2004/0111594 A1
(43) Pub. Date: Jun. 10, 2004

(54) Multithreading recycle and dispatch mechanism

(75) Inventors: Kurt Alan Feiste, Austin, TX (US); David Shippy, Austin, TX (US); Albert James Van Norstrand JR., Round Rock, TX (US)

Correspondence Address: Gregory W. Carr, 670 Founders Square, 900 Jackson Street, Dallas, TX, 75202, US

(73) Assignee: International Business Machines Corporation, Armonk, NY

(21) Appl. No.: 10/313,705

(22) Filed: Dec. 5, 2002

(51) Int. Cl. G06F 7/38; G06F 15/00

(52) U.S. Cl. 712/245

(57) ABSTRACT

A system and method is provided for improving throughput of an in-order multithreading processor. A dependent instruction is identified to follow at least one long latency instruction with register dependencies from a first thread. The dependent instruction is recycled by providing it to an earlier pipeline stage. The dependent instruction is delayed at dispatch. The completion of the long latency instruction is detected from the first thread. An alternate thread is allowed to issue one or more instructions while the long latency instruction is being executed.

### BACKGROUND OF THE INVENTION

1. Field of the Invention

The invention relates generally to improving throughput of an in-order processor and, more particularly, to multithreading techniques in an in-order processor.

2. Description of the Related Art

“Multithreading” is a common technique used in computer systems to allow multiple threads to run on a shared dataflow. If used in a single-processor system, multithreading gives operating system software of the single-processor system the appearance of a multi-processor system.

There are several multithreading techniques used in the prior art. For example, coarse-grain multithreading allows only one thread to be active at a time and flushes the entire pipeline whenever there is a thread swap. In this technique, a single thread runs until it encounters an event, such as a cache miss, and then the pipeline is drained and the alternate thread is activated (i.e., swapped in).

In another example, simultaneous multithreading (SMT) allows multiple threads to be active simultaneously and uses the resources of an out-of-order design, such as register renaming, and completion reorder buffers to track the multiple active threads. SMT can be fairly expensive in hardware implementation.

Therefore, a need exists for a system and method for improving throughput of an in-order multithreading processor without using the out-of-order design technique.

### SUMMARY OF THE INVENTION

The present invention provides a system and method for improving throughput of an in-order multithreading processor. A dependent instruction is identified to follow at least one long latency instruction with register dependencies from a first thread. The dependent instruction is recycled by providing it to an earlier pipeline stage. The dependent instruction is delayed at dispatch. The completion of the long latency instruction is detected from the first thread. An alternate thread is allowed to issue one or more instructions while the long latency instruction is being executed.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram illustrating multithreading instruction flows in a processor;

FIG. 2 is a timing diagram illustrating normal thread switching; and

FIG. 3 is a timing diagram illustrating thread switching when a dependent instruction follows a load miss in a thread.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail.

It is further noted that, unless indicated otherwise, all functions described herein may be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

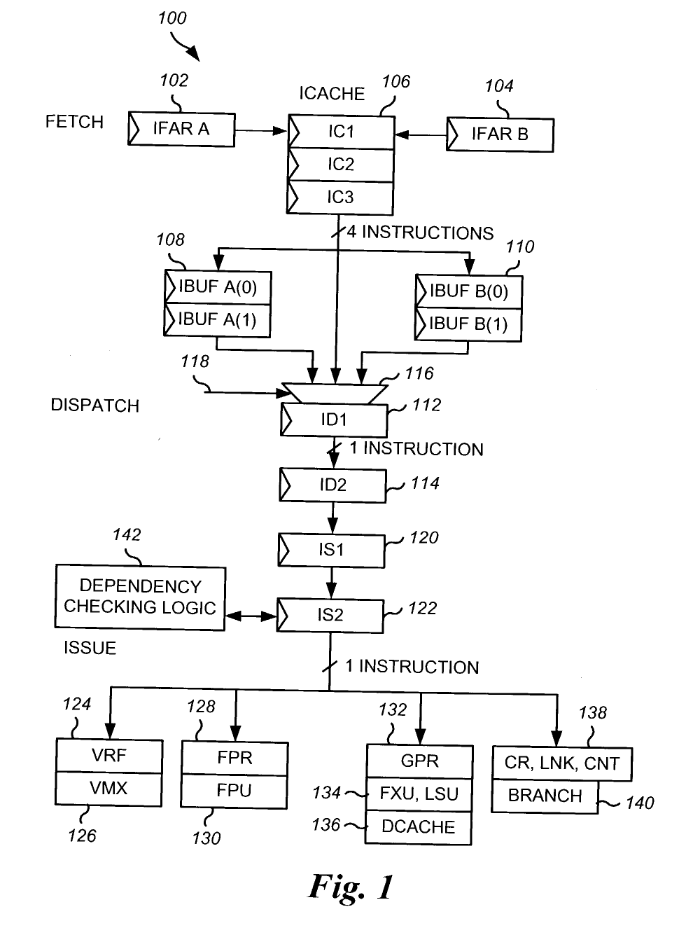

Referring to FIG. 1 of the drawings, the reference numeral 100 generally designates a processor 100 having multithreading instruction flows in a block diagram. Preferably, the processor 100 is an in-order multithreading processor. The processor 100 has two threads (A and B); however, it may have more than two threads.

The processor 100 comprises instruction fetch address registers (IFARs) 102 and 104 for threads A and B, respectively. The IFARs 102 and 104 are coupled to an instruction cache (ICACHE) 106 having IC1, IC2 and IC3. The processor 100 also comprises instruction buffers (IBUFs) 108 and 110 for threads A and B, respectively. Each of the IBUFs 108 and 110 is two entries deep and four instructions wide. Specifically, IBUF 108 comprises IBUF A(0) and IBUF A(1). Similarly, IBUF 110 comprises IBUF B(0) and IBUF B(1). The processor 100 further includes instruction dispatch blocks ID1 112 and ID2 114. The ID1 112 includes a multiplexer 116 coupled to the ICACHE 106 and the IBUFs 108 and 110. The multiplexer 116 is configured to receive a thread dispatch request signal 118 as a control signal. The ID1 112 is also coupled to the ID2 114.

The processor 100 further comprises instruction issue blocks IS1 120 and IS2 122. The IS1 120 is coupled to the ID2 114 to receive an instruction. The IS1 120 is also coupled to the IS2 122 to transmit the instruction to the IS2 122. The processor 100 further comprises various register files coupled to execution units in order to process the instruction. Specifically, the processor 100 comprises a vector register file (VRF) 124 coupled to a vector/SIMD multimedia extension (VMX) 126. The processor 100 also comprises a floating-point register file (FPR) 128 coupled to a floating-point unit (FPU) 130. Further, the processor 100 comprises a general-purpose register file (GPR) 132 coupled to a fixed-point unit/load-store unit (FXU/LSU) 134 and a data cache (DCACHE) 136. The processor 100 also includes condition register file/link register file/count register file (CR/LNK/CNT) 138 and a branch 140. The IS2 122 is coupled to the VRF 124, the FPR 128, the GPR 132, and the CR/LNK/CNT 138. The processor 100 also comprises a dependency checking logic 142, which is preferably coupled to the IS2 122.

Instruction fetch will maintain separate IFARs 102 and 104 per thread. Fetching will alternate every cycle between threads. The instruction fetch is pipelined and takes three cycles in this implementation. At the end of the three cycles, four instructions are fetched from the ICACHE 106 and forwarded to the ID1 112. The four instructions are either dispatched or inserted into the IBUFs 108 and/or 110.

The selection for thread switch is determined at the ID1 112. The determination is based on the thread dispatch request signal 118 and available instructions for that thread. Preferably, the thread dispatch request signal 118 toggles every cycle per thread. If there is an available instruction for a given thread and it is an active thread for that thread, then an instruction will be dispatched for that thread. If there are no available instructions for a thread during its active thread cycle, then an alternate thread can use this dispatch slot if it has available instructions.

In a prior art system, when a long latency instruction is followed by a dependent instruction in a first thread (e.g., thread A), the dependent instruction cannot be executed until the long latency instruction is processed. Therefore, the dependent instruction will be stored in the IS2 122 until the long latency instruction is processed. In the present invention, however, the dependency checking logic 142 identifies the dependent instruction following the long latency instruction. Preferably, the dependent instruction is marked so that the dependency checking logic will be able to identify it. The dependent instruction is recycled by providing the dependent instruction to an earlier pipeline stage (e.g., the fetch stage). The dependent instruction is delayed at dispatch. An alternate thread is allowed to issue one or more instructions while the long latency instruction is being executed. Upon completion of the long latency instruction, the dependent instruction of the first thread gets executed.

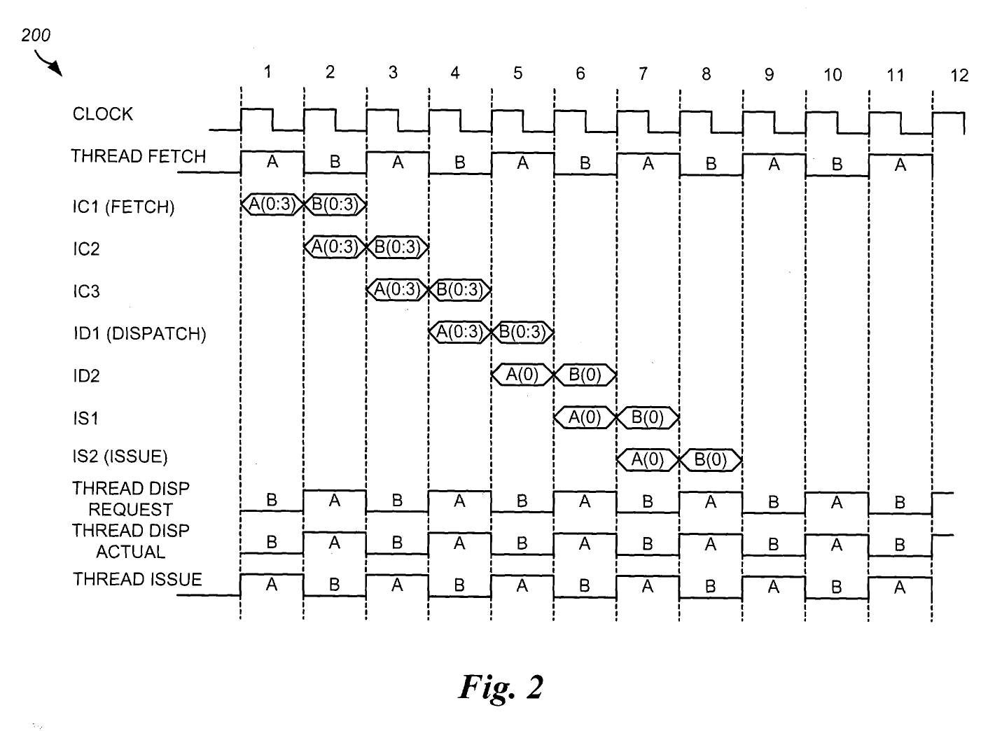

Now referring to FIG. 2, a timing diagram 200 illustrates normal thread switching. The timing diagram 200 shows normal fetch, dispatch and issue processes with no branch redirects or pipeline stalls. Preferably, fetch, dispatch and issue processes alternate between threads every cycle. Specifically, A(0:3) is the group of four instructions fetched for thread A. Similarly, B(0:3) is the group of four instructions fetched for thread B. There are no branches so that both fetch and dispatch toggles threads every cycle.

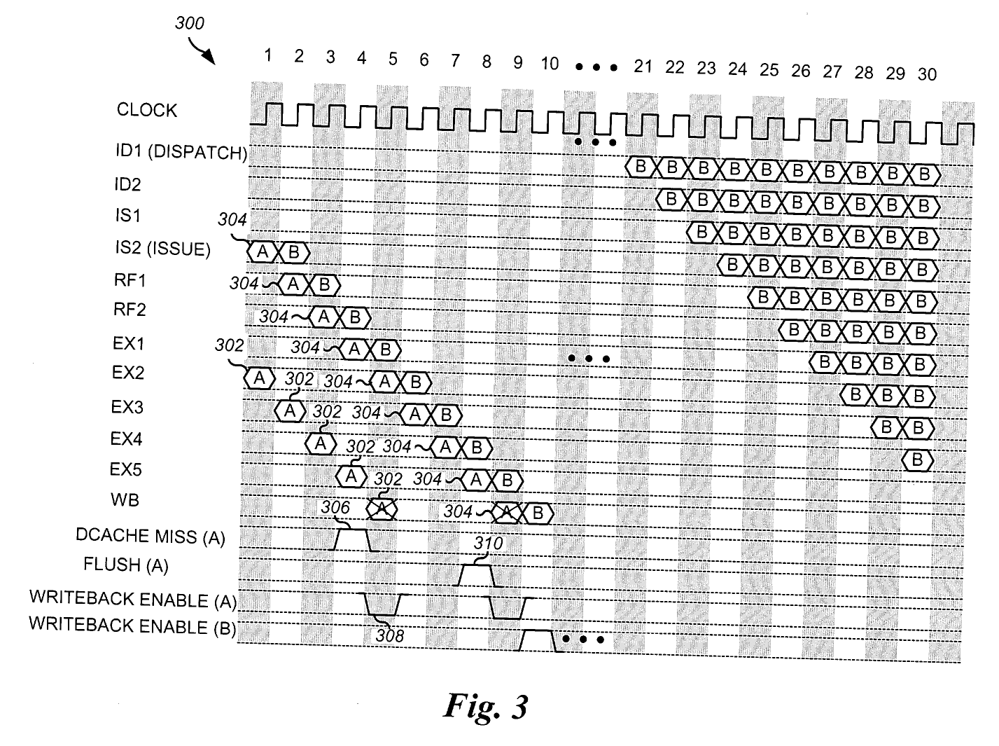

Now referring to FIG. 3, a timing diagram 300 shows a DCACHE load miss on thread A followed by a dependent instruction on thread A. In cycle 1, the load 302 is in pipeline stage EX2. In cycle 1, a dependent instruction 304 in thread A is in pipeline stage IS2. In cycle 4, a DCACHE miss signal 306 is activated. This in turn causes a writeback enable signal 308 for thread A to be disabled. In cycle 7, the dependent instruction 304 in thread A is flushed by a FLUSH (A) signal 310. The dependent instruction 304 will then be recycled and held at dispatch until the data returns from the load that missed the DCACHE. After the flush occurs, thread B is given all of the dispatch slots starting in cycle 21. This continues until the DCACHE load data returns.

It is noted that, after the load 302 is completely executed, the thread A sends the dependent instruction 304 through the pipeline for execution.

A long latency instruction may take many different forms. A load miss as shown in FIG. 3 is one example of the long latency instruction. Additionally, there are other types of long latency instructions including, but not limited to: (1) an address translation miss; (2) a fixed point complex instruction; (3) a floating point complex instruction; and (4) a floating point denorm instruction. Although FIG. 3 shows a load miss case, it will be generally understood by a person of ordinary skill in the art that the present invention is applicable to other types of long latency instructions as well.

It will be understood from the foregoing description that various modifications and changes may be made in the preferred embodiment of the present invention without departing from its true spirit. This description is intended for purposes of illustration only and should not be construed in a limiting sense. The scope of this invention should be limited only by the language of the following claims.

1. A method for improving throughput of an in-order multithreading processor, the method comprising the steps of:
identifying a dependent instruction following at least one long latency instruction with register dependencies from a first thread;
recycling the dependent instruction by providing the dependent instruction to an earlier pipeline stage;
delaying the dependent instruction at dispatch;
detecting completion of the at least one long latency instruction from the first thread; and
allowing an alternate thread to issue one or more instructions while the at least one long latency instruction is being executed.

2. The method of claim 1, wherein the step of delaying the dependent instruction at dispatch comprises the step of holding the dependent instruction in an instruction buffer.

3. The method of claim 2, wherein a dispatch block mark indicates that the dependent instruction is to be held in the instruction buffer.

4. The method of claim 3, wherein the dispatch block mark is reset to indicate that the dependent instruction is to be released from the instruction buffer.

5. The method of claim 1, wherein the at least one long latency instruction is a load miss.

6. The method of claim 5, further comprising the steps of:
issuing a load/store instruction;
tracking target dependency of the load/store instruction;
saving the load/store instruction in a miss queue;
executing the load/store instruction;
signalling a load miss;
flushing a subsequent dependent instruction;
holding the dependent instruction at dispatch while dispatching other instructions for an alternative thread; and
dispatching the dependent instruction.

7. The method of claim 1, wherein the at least one long latency instruction is an address translation miss.

8. The method of claim 1, wherein the at least one long latency instruction is a fixed point complex instruction.

9. The method of claim 1, wherein the at least one long latency instruction is a floating point complex instruction.

10. The method of claim 1, wherein the at least one long latency instruction is a floating point denorm instruction.

11. An in-order multithreading processor having two or more threads, comprising:
a plurality of instruction fetch address registers, at least one of the instruction fetch address registers being assigned to each of the two of more threads;
an instruction cache coupled to the plurality of instruction fetch address registers;
a plurality of instruction buffers, at least one of the instruction buffers being assigned to each thread, the plurality of instruction buffers being coupled to the instruction cache for receiving one or more instructions from the instruction cache;
an instruction dispatch stage coupled to both the instruction cache and the plurality of instruction buffers;
an instruction issue stage coupled to the instruction dispatch stage;
a dependency checking logic coupled to the instruction issue stage for identifying a dependent instruction following at least one long latency instruction with register dependencies from the first thread;
the dependency checking logic for recycling the dependent instruction by providing the dependent instruction to an earlier pipeline stage;
the dependency checking logic for delaying the dependent instruction at dispatch;
the dependency checking logic for detecting completion of the at least one long latency instruction from the first thread; and
the dependency checking logic for allowing the alternate thread to issue the one or more instructions while the at least one long latency instruction is being executed.

12. The in-order multithreading processor of claim 11, wherein the issue stage comprises at least one register file and at least one execution unit coupled to the register file.

13. The in-order multithreading processor of claim 12, wherein the at least one register file comprises a vector register file (VRF), and wherein the at least one execution unit comprises vector/SIMD multimedia extension (VMX).

14. The in-order multithreading processor of claim 12, wherein the at least one register file comprises a floating-point register file (VPR), and wherein the at least one execution unit comprises a floating-point unit (FPU).

15. The in-order multithreading processor of claim 12, wherein the at least one register file comprises a general-purpose register file (GPR), and wherein the at least one execution unit comprises a fixed-point unit (FXU) and a load/store unit (LSU).

16. The in-order multithreading processor of claim 12, wherein the at least one register file comprises a condition register file (CR), a link register file (LNK) and count register file (CNT), and wherein the at least one execution unit comprises a branch.

17. An in-order multithreading processor having two or more threads, comprising:
means for identifying a dependent instruction following at least one long latency instruction with register dependencies from a first thread;
means for recycling the dependent instruction by providing the dependent instruction to an earlier pipeline stage;
means for delaying the dependent instruction at dispatch;
means for detecting completion of the at least one long latency instruction from the first thread; and
means for allowing an alternate thread to issue one or more instructions while the at least one long latency instruction is being executed.

18. The in-order multithreading processor of claim 17, wherein the means for delaying the dependent instruction at dispatch comprises means for holding the dependent instruction in an instruction buffer.

19. The in-order multithreading processor of claim 18, wherein a dispatch block mark indicates that the dependent instruction is to be held in the instruction buffer.

20. The in-order multithreading processor of claim 19, wherein the dispatch block mark is reset to indicate that the dependent instruction is to be released from the instruction buffer.

21. The in-order multithreading processor of claim 17, wherein the at least one long latency instruction is a load miss.

22. The in-order multithreading processor of claim 21, further comprising:
means for issuing a load/store instruction;
means for tracking target dependency of the load/store instruction;
means for saving the load/store instruction in a miss queue;
means for executing the load/store instruction;
means for signalling a load miss;
means for flushing a subsequent dependent instruction;
means for holding the dependent instruction at dispatch while dispatching other instructions for an alternative thread; and
means for dispatching the dependent instruction.

23. The in-order multithreading processor of claim 17, wherein the at least one long latency instruction is an address translation miss.

24. The in-order multithreading processor of claim 17, wherein the at least one long latency instruction is a fixed point complex instruction.

25. The in-order multithreading processor of claim 17, wherein the at least one long latency instruction is a floating point complex instruction.

26. The in-order multithreading processor of claim 17, wherein the at least one long latency instruction is a floating point denorm instruction.

27. A computer program product for improving throughput of an in-order multithreading processor, the computer program product having a medium with a computer program embodied thereon, the computer program comprising:
computer program code for identifying a dependent instruction following at least one long latency instruction with register dependencies from the first thread;
computer program code for recycling the dependent instruction by providing the dependent instruction to an earlier pipeline stage;
computer program code for delaying the dependent instruction at dispatch;
computer program code for detecting completion of the at least one long latency instruction from the first thread; and
computer program code for allowing the alternate thread to issue one or more instructions while the at least one long latency instruction is being executed.

28. The computer program product of claim 27, wherein the computer program code for delaying the dependent instruction at dispatch comprises computer program code for holding the dependent instruction in an instruction buffer.
